(19) United States
(12) Patent Application Publication
(10) Pub. No.: US 2026/0254515 A1
(43) Pub. Date: Aug. 27, 2026

(54) MESH TOPOLOGY FOR SUB-THZ DEPLOYMENT

(71) Applicant: QUALCOMM Incorporated, San Diego, CA (US)

(72) Inventors: Michael LEVITSKY, Rehovot (IL); Gideon Shlomo KUTZ, Ramat Hasharon (IL); Assaf TOUBOUL, Netanya (IL)

(21) Appl. No.: 18/992,957

(22) PCT Filed: Aug. 21, 2023
(86) PCT No.: PCT/US2023/030700

§ 371 Date: Jan. 9, 2025

(30) Foreign Application Priority Data
Sep. 6, 2022 (IL) 296245

(51) Int. Cl. H04B 7/06; H04B 7/155

(52) U.S. Cl. CPC H04B 7/06952; H04B 7/1555

(57) ABSTRACT

Apparatus, methods, and computer program products for utilizing sub-Terahertz (THz) communication are provided. An example method may include establishing a first communication with a network entity on a primary cell. The example method may further include transmitting, to the network entity via the primary cell, a capability indication associated with the first wireless device. The example method may further include receiving, from the network entity based on the capability indication via the primary cell, an activation for a sub-THz communication associated with a UE and a configuration of a synchronization and beam management session for the first wireless device, the sub-THz communication being on a first frequency range that does not include a second frequency of the first communication. The example method may further include communicating, with the UE and the network entity via the sub-THz communication, at least one data channel transmission.

### CROSS-REFERENCE TO RELATED APPLICATION

This application claims the benefit of Israel Patent Application Serial No. 296245, entitled “MESH TOPOLOGY FOR SUB-THZ DEPLOYMENT” and filed on Sep. 6, 2022, which is expressly incorporated by reference herein in its entirety.

### TECHNICAL FIELD

The present disclosure relates generally to communication systems, and more particularly, to wireless communication systems with sub-Terahertz (THz) communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a network entity are provided. The apparatus may include a memory and at least one processor coupled to the memory. The memory and the at least one processor coupled to the memory may be configured to establish a first communication with a user equipment (UE) on a primary cell. The memory and the at least one processor coupled to the memory may be configured to receive, from a first sub-THz repeater via the primary cell, a capability indication. The memory and the at least one processor coupled to the memory may be configured to transmit an activation for a sub-THz communication for the UE, the sub-THz communication being on a first frequency range that does not include a second frequency of the first communication. The memory and the at least one processor coupled to the memory may be configured to transmit, for the first sub-THz repeater based on the capability indication, the activation for the sub-THz communication. The memory and the at least one processor coupled to the memory may be configured to communicate, via the primary cell, scheduling information for at least one data channel transmission. The memory and the at least one processor coupled to the memory may be configured to communicate, via the first sub-THz repeater and the sub-THz communication, the at least one data channel transmission.

In another aspect of the disclosure, a method, a computer-readable medium, and an apparatus at a repeater are provided. The apparatus may include a memory and at least one processor coupled to the memory. The memory and the at least one processor coupled to the memory may be configured to establish a first communication with a network entity on a primary cell. The memory and the at least one processor coupled to the memory may be configured to transmit, to the network entity via the primary cell, a capability indication associated with the first wireless device. The memory and the at least one processor coupled to the memory may be configured to receive, from the network entity based on the capability indication via the primary cell, an activation for a sub-Terahertz (THz) communication associated with a user equipment (UE) and a configuration of a synchronization and beam management session for the first wireless device, the sub-THz communication being on a first frequency range that does not include a second frequency of the first communication. The memory and the at least one processor coupled to the memory may be configured to communicate, with the UE and the network entity via the sub-THz communication, at least one data channel transmission.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and

an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating example sub-THz deployment.

FIG. 5 is a diagram illustrating different scenarios of sub-THz deployment.

FIG. 6 is a diagram illustrating example communications between a network entity and a UE via one or more repeaters.

FIG. 7A is a diagram illustrating example mesh network scenario of sub-THz deployment.

FIG. 7B is a diagram illustrating example mesh network scenario of sub-THz deployment.

FIG. 8 is a diagram illustrating example mesh network scenario of sub-THz deployment.

FIG. 9 is a flowchart of a method of wireless communication.

FIG. 10 is a flowchart of a method of wireless communication.

FIG. 11 is a diagram illustrating an example of a hardware implementation for an example network entity.

FIG. 12 is a diagram illustrating an example of a hardware implementation for a network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

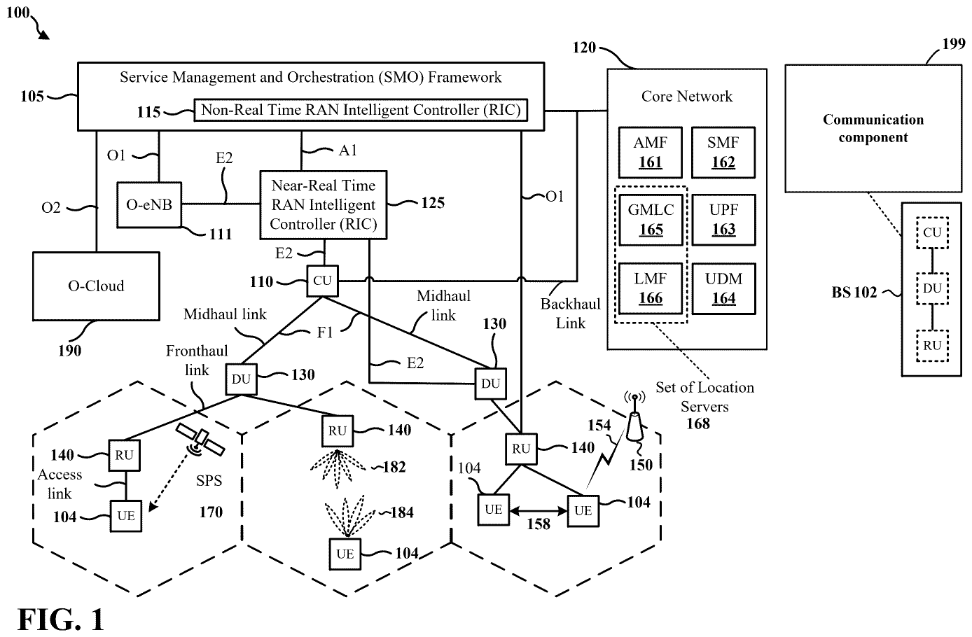

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an 02 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell). Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU.

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the base station 102 or a network entity (such as a repeater) may include a communication component 199. In some aspects, the communication component 199 may be configured to establish a first communication with a UE and a first sub-THz repeater on a primary cell. In some aspects, the communication component 199 may be configured to receive, from a first sub-THz repeater via the primary cell, a capability indication related to a sub-THz band. In some aspects, the communication component 199 may be configured to transmit an activation for a sub-THz communication for the UE and a configuration of a synchronization and beam management session for the first sub-THz repeater, the sub-THz communication being on a first frequency range that does not include a second frequency of the first communication. In some aspects, the communication component 199 may be configured to transmit, for the first sub-THz repeater based on the capability indication, the activation for the sub-THz communication. In some aspects, the communication component 199 may be configured to communicate, via the primary cell, scheduling information for at least one data channel transmission over the sub-THz band for the UE. In some aspects, the communication component 199 may be configured to communicate, via the first sub-THz repeater and the sub-THz communication, the at least one data channel transmission for the UE. In some aspects, the communication component 199 may be configured to establish a first communication with a network entity on a primary cell. In some aspects, the communication component 199 may be configured to transmit, to the network entity via the primary cell, a capability indication associated with the first wireless device. In some aspects, the communication component 199 may be configured to receive, from the network entity based on the capability indication via the primary cell, an activation for a sub-THz communication associated with a UE and a configuration of a synchronization and beam management session for the first wireless device, the sub-THz communication being on a first frequency range that does not include a second frequency of the first communication. In some aspects, the communication component 199 may be configured to communicate, with the UE and the network entity via the sub-THz communication, at least one data channel transmission.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

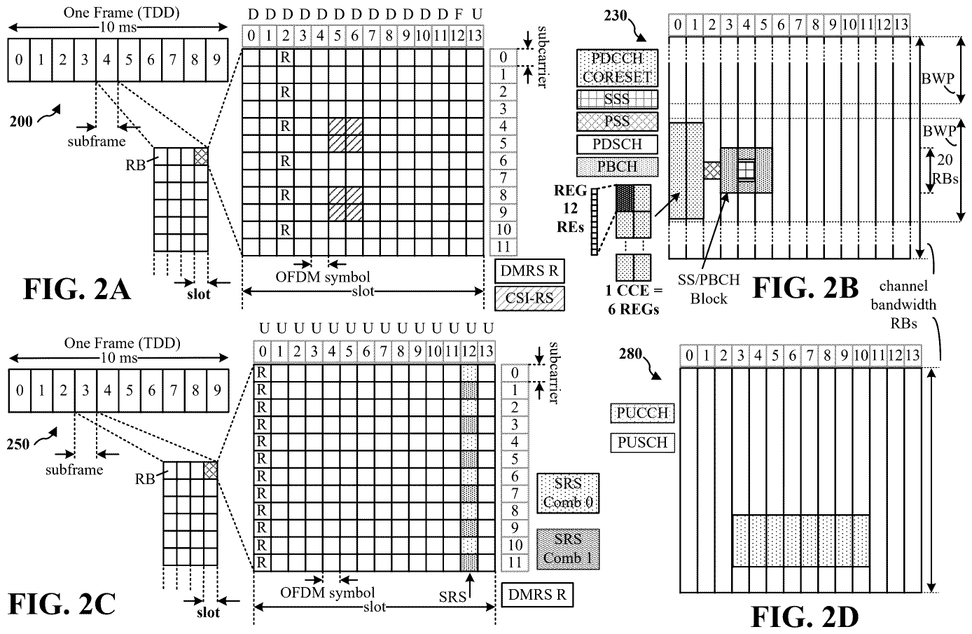

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI).

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}* 15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

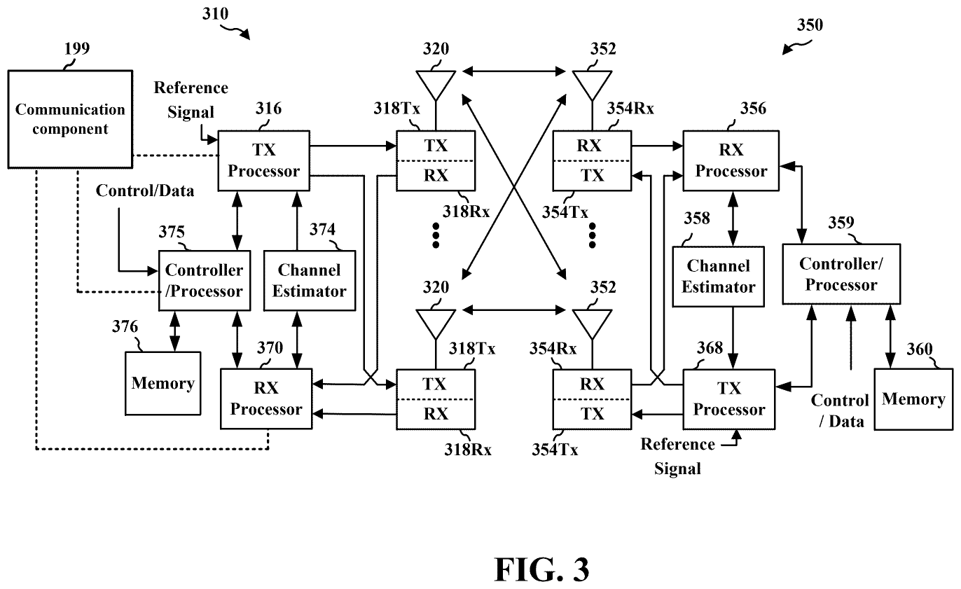

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality. The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 316, the RX processor 370, and the controller/processor 375 may be configured to perform aspects in connection with communication component 199 of FIG. 1.

Sub-THz may refer to a frequency range larger than 90 GHz and smaller than 1 THz (e.g., smaller than 300 GHz). Sub-THz communications may be used in wireless communication systems to increase overall communication capacity and throughput. For massive sub-THz deployment, there may be several challenges. First, sub-THz may be associated with a lower maximum power amplifier (PA) PA output power characteristics (e.g., about 10 decibel (dB) less compared to millimeter wave (mmW) bands). Due to a much higher signal bandwidth (BW) for sub-THz and the relatively low maximum PA output power, effective isotropic radiated power (EIRP) deficit may be present for sub-THz link. Correspondingly, this EIRP deficit contributes to a more limited sub-THz link coverage compared to mmW bands (one of the main challenges for sub-THz link). EIRP deficit for sub-THz can be partially compensated by a higher BF gain, but this is limited by a practical beam width considerations (higher beamformer gain/directivity results in a narrower beams that lead to a not robust system where it may be very challenging to maintain an accurate beam tracking/beam management procedures).

In addition, for sub-THz deployment, because there may be an at least factor 2 reduction in sub-THz PA efficiency (e.g., compared with mmW), a sub-THz link power consumption characteristics/energy efficiency may be poor. Correspondingly, another challenge associated with sub-THz deployment may be a higher power consumption for sub-THz Rx/Tx (compared with lower frequency) (e.g., due to a higher signal BW and lower PA power efficiency) and extremely high data rates. The higher power consumption may be contributed by a less power efficient RF processing, a higher power consumption related to analog-to-digital or digital-to-analog components having an increased sampling rates (which may be approximately linearly translated to the consumed power increase), higher rate digital processing, high bit rates to be addressed on the decoder side, higher memory/storage (intermediate buffers) related power consumption, or the like. Aspects provided herein provide mechanisms to address the challenges associated with sub-THz while providing the benefit of extremely high data rate/link capacity that can be achieved with sub-THz communication. In some aspects, sub-THz communication may be used via non-standalone (non-SA) or non-self-contained deployment (e.g., deployed with other frequency bands such as FR1/FR2 and not deployed by itself). In some aspects, sub-THz communication may be used for UE data/cell traffic offload for “data hungry” UEs that would use a high data rate. In some aspects, sub-THz communication may be used for offloading traffic (e.g., DL/UL traffic) by utilizing sub-THz “access points” (APs) (and may be otherwise referred to as “repeaters”) in areas with high data volume demand potential. In some aspects, these APs may provide per demand high capacity channel for sub-THz eligible (e.g., supporting sub-THz communication and satisfying a list of preconditions) UEs registered and continuously connected to a lower frequency band primary cell or “master” cell (e.g., FR1/FR2 based cell which may also be referred to as “PCell” or “Pcell” or also as a secondary cell on a lower frequency band compared to sub-THz band) while these APs can provide a local spot-based coverage with increased capacity under a wider Pcell (e.g., FR1 based Pcell) or a lower frequency band Scell (e.g., FR2 based Scell) coverage range. The sub-THz communication may be a supplementary high capacity channel that may be deployed as a secondary cell (which may also be referred to as “SCell” or “Scell”) with burst activity pattern for sparse usage in time for sub-THz eligible UEs. The sub-THz eligible UE should be continuously connected to the PCell via the lower frequency band (e.g., FR1/FR2/FR4) as one of the prerequisites for a more power efficient spot based non-SA sub-THz deployment that will rely on inter band carrier aggregation. As used herein, the term “primary cell” or “master cell” may be used interchangeably and may refer to a lower frequency band cell where initial connection between the sub-THz eligible UE and gNB is established and continuously maintained, while this continuous connection is used as a reference for coarse synchronization and beam management procedures for higher frequency band based Scell (e.g., sub-THz based) and that is also used for all the registration and any control plane signaling for sub-THz based secondary cell. As used herein, the term “secondary cell” may refer to a non-primary cell. Correspondingly, sub-THz based Scell will support a minimum scope of critical functionality and will strongly rely on Pcell connectivity in many aspects (sub-THz related control signaling, coarse synchronization and coarse beam management supporting a dynamic low latency and low power and low complexity activation/deactivation procedures). Sub-THz based Scell will allow a spot-based coverage under a lower band Pcell coverage range and will be used mostly for a significant volume data offloading using a relatively short data offloading sessions for sub-THz eligible UEs (with preconditions). This type of sub-THz deployment (Scell with min scope of critical functionality and a strong reliance on Pcell/“master” cell allowing a dynamic low latency, low complexity activation/deactivation procedures to support a burst activity pattern of sub-THz Scell) is supposed to allow an improved power efficiency of sub-THz deployment for a wider range of scenarios and use cases.

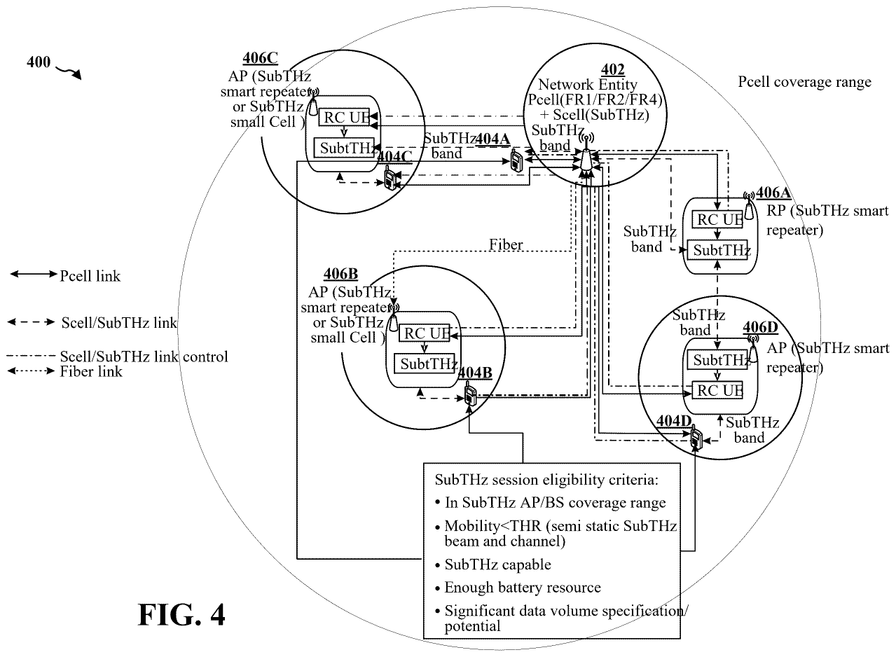

FIG. 4 is a diagram 400 illustrating example sub-THz deployment. By way of example, a network entity (e.g., a gNB or a different type of network entity) 402 and a UE 404A, a UE 404B, a UE 404C, a UE 404D, and a RP 406A, an AP 406B, an AP 406C, and an AP 406D are illustrated. As illustrated in FIG. 4, inter-band carrier aggregation (CA) may be used where sub-THz is used on a Scell providing a spot based sub-THz coverage under a wider Pcell coverage range and Pcell may be based on a lower frequency band (FR1/FR2/FR4). Sub-THz Scell may support a minimum critical scope of functionality and may rely on Pcell/lower frequency band cell in many aspects such that Scell may not support any “always on” signals or resources reservation (e.g., signal that are always present on the sub-THz Scell like SSB or RACH occasions or any periodic RS signals or control signaling resources). In some aspects, Scell may be activated dynamically on demand, e.g., for sporadic and short time sessions, that may have a burst activity pattern. Coarse synchronization and beam management for Scell/sub-THz may be determined based on lower frequency band Pcell/“master” cell. There may be a complementary synchronization and beam refinement procedures carried out per Scell activation and the Scell synchronization and beam management (BM) may be at least partially based on Pcell. As illustrated in FIG. 4, there may be single or multi hop repeating (e.g., enabled by the RP 406A and the AP 406D to the UE 404D) between sub-THz UE and sub-THz network entity (e.g., the network entity 402) transceiver to bridge over a limited sub-THz range. The APs (or another type of smart repeater such as RP 406A) may be efficient smart repeaters with out-of-band (OOB) control based on Pcell connectivity of all the sub-THz link components (UEs, APs or intermediate repeaters in case of multi hop sub-THz links). The APs may include different functional parts including: (1) a reduced capability (RedCap) UE (RC UE) for Pcell connectivity (e.g., to deliver OOB control/reports/feedbacks), (2) an analog amplify & forward (AF) functionality for sub-THz data forwarding, and (3) dedicated network entity for sub-THz local complementary synchronization and beam management sessions using a dedicated synchronization and beam management RS (or modified waveform localized in time SSB mini bursts) Tx/Rx capability over sub-THz on Scell. Multi hop sub-THz links may be established/activated and synchronized using progressive synchronization across hops with hop specific synchronization and BM sessions with customized synchronization & BM RS/SSB mini burst scheduling (by gNB over Pcell) for transmission and reception from a first sub-THz hop edge (Tx side) to a corresponding second sub-THz hop edge (Rx side to sync on the Tx side). Based on aspects provided herein, the synchronization and beam management procedure procedures may be fast, low power, low latency, and per Scell activation. In some aspects, to be eligible for a sub-THz session, the UE may be in a sub-THz AP or base station coverage range, may have a mobility less than a threshold (e.g., for semi-static sub-THz beam and channel), may be sub-THz capable, may have enough battery resource, and may have a data volume potential or specification above a threshold.

In some aspects, sub-THz communication may be supported in a non-SA fashion as a Scell (or secondary component carrier) while the corresponding Pcell (or primary component carrier) may be on a lower frequency range (e.g., FR1/FR2/FR4) and may serve as master cell connectivity to support the sub-THz communication (which may be with a burst activity pattern). In some aspects, the term “Pcell” may be used interchangeably with the term “primary component carrier” and the term “Scell” may be used interchangeably with the term “secondary component carrier.”

In some aspects, when a sub-THz eligible UE has a connectivity over both FR1 and FR2/FR4 cells/CCs, a higher frequency band related cell/CC may be used as master cell for sub-THz communication even if it is not viewed as a Pcell from the network perspective. For example, if several FR1 CCs and several FR2 CCs are activated for a sub-THz eligible UE, where one of FR1 CCs is configured as a primary CC (Pcell), in context of sub-THz connectivity, one of FR2 CCs will be addressed as a “master cell” /CC for sub-THz. In some aspects, a network entity or a transceiver supporting sub-THz communication may be collocated or not collocated with a network entity or a transceiver supporting lower frequency band communication for Pcell/master cell. In some aspects, the network entity or the transceiver supporting sub-THz communication may be in a coverage range of the network entity or the transceiver supporting lower frequency band communication for Pcell/master cell to allow a sub-THz eligible UE to be continuously connected to the Pcell as a condition for sub-THz link establishment (e.g., and continuously connected to the Pcell even when it's using sub-THz communication for data offloading). As used herein, the term “network entity” may refer to the network supported by transceiver(s), IAB(s), gNB(s), smart repeater(s), radio remote head (RRH), or the like. In some aspects, sub-THz transceiver may be connected to a PCell network entity or base station via wireline or wireless connection such as fiber (digital or analog), ethernet, coax, IAB link over sub-THz, or the like.

As used herein, the term “repeater” may refer to a network controlled repeater (e.g., which may be an access point (AP) for direct connection with UEs, a rendezvous point (RP) for intermediate or direct link with network entity, such as base station, or a mixed type that combines functionality of AP and RP) that may receive a transmission, and perform amplify and forward (AF) to transmit the transmission to a UE, a network entity, or another repeater. As used herein, the term “sub-THz repeater” may refer to a repeater for a network controlled amplifying and forwarding sub-THz transmissions (e.g., control information for a sub-THz repeater may be on a different frequency band).

For sub-THz, in order to achieve a denser sub-THz coverage, a denser geographical distribution of sub-THz transceivers may be used. If each sub-THz coverage spot is associated with a sub-THz network entity/IAB/small cell (with a direct links to sub-THz eligible UEs), a full digital demodulation and decoding procedures of sub-THz signals may be done locally for each spot before backhauling the integrated and remodulated data to a Pcell network entity. Given a high number of sub-THz transceivers that may be used to cover Pcell coverage range, the power consumption in the Sub-THz network may be very large. Aspects provided herein provide mechanisms for enabling multi-hop (e.g., based on multi hop links enabled by multiple repeaters) sub-THz deployment to increase the supported spot-based sub-THz coverage range/coverage density with a reduced power consumption or energy investment to allow a more power efficient sub-THz deployment. In order to improve NW energy efficiency characteristics for sub-THz deployment, aspects provided herein may enable an extended range multi-hop sub-THz links based on network controlled repeaters with mostly analog sub-THz signal processing (AP/RP) and OOB control over a lower frequency band connectivity allowing a non-direct UE to sub-THz network entity connection to be employed instead of a more power-hungry approach based on multiple sub-THz small cells/IABs.

In some aspects, extended range sub-THz links between sub-THz eligible UEs and sub-THz network entity may be enabled by usage of one or more intermediate sub-THz repeaters. The resulting multi-hop links based on usage of one or more intermediate sub-THz repeaters may allow a range comparable with Pcell coverage range (which may enable sub-THz to be deployed as a Scell while Pcell connectivity is present) across the entire Pcell coverage area_and not based on multiple sub-THz small cells/IABs, which may have a higher power/energy consumption characteristics compared to repeaters with mostly analog processing. In some aspects, more than one sub-THz smart repeater may be used for long range sub-THz link establishment. In some aspects, line-of-sight (LOS) link may be available between different involved sub-THz repeaters and also between the sub-THz network entity and the nearest sub-THz repeater connected to it. NLOS Sub-THz link may be applicable as a direct link with a sub-THz eligible UE (access link). For NLOS sub-THz link there may be a very high penetration loss that may be contributed to sub-THz link path loss due to a poor penetration characteristic for sub-THz such that NLOS sub-THz link range may be very limited.

As an example, a repeater may be classified into different types, AP, RP or mixed type. An AP may be a repeater that provides local sub-THz coverage spot and has a direct links with a sub-THz eligible UEs (access link). An RP may be a repeater that is used as an intermediate repeater between other sub-THz smart repeaters or between another smart repeater and sub-THz network entity. In some aspects, an RP may not provide a local sub-THz coverage spot and does not have a direct link with a sub-THz UE and may have connection with other repeaters involved in the multi-hop link or a direct connection with a sub-THz network entity (donor link or intermediate backhauling link). A mixed type repeater may be with functionality of both AP and RP and may simultaneously serve as an intermediate repeater and provides a local sub-THz coverage spot. In some aspects, different types of repeater (RP/AP/mixed) may follow the same link establishment and synchronization and beam management (BM) procedures but may have different hardware and BM capabilities. For example, a repeater providing a local coverage spot (AP/mixed type) may support a full/wide spatial coverage. An RP may support a relatively narrow spatial sectors which are relevant for LOS links to other repeaters or network entity.

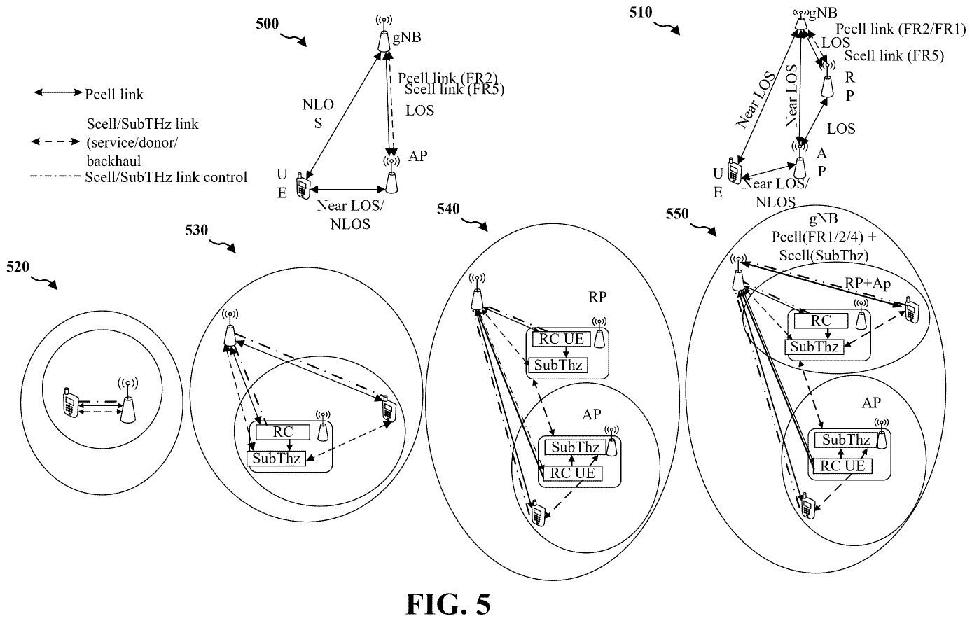

FIG. 5 is a diagram illustrating different scenarios, such as example 500, example 510, example 520, example 530, example 540, and example 550 of sub-THz deployment. As illustrated in example 500, in some aspects, there may be one repeater in the link. A single repeater may be used for sub-THz link for a UE having a non-line-of-sight (NLOS) direct channel with sub-THz network entity. The Pcell connectivity (e.g., which may be on a different frequency range than sub-THz, such as FR2 or FR1) may be present for all the components of multi-hop sub-THz link.

As illustrated in example 510, in some aspects, two repeaters may be used for sub-THz link for UE having a long distance Near line-of-sight (LOS) direct channel with a sub-THz network entity. The Pcell connectivity (e.g., which may be on a different frequency range than sub-THz, such as FR2 or FR1) may be present for all the components of multi-hop sub-THz link. As an example, near LOS link over FR2 may have approximately three times larger range than over FR5 or higher frequency and hence LOS connectivity over the extended range may be used for sub-THz to bridge over a gap. Two or more sub-THz repeaters (including the AP and the RP) with LOS interconnection between them and LOS link to sub-THz network entity may be used.

As illustrated in example 520, in some aspects, there may be no repeaters and the UE may be directly connected with the network entity. As illustrated in example 530, in some aspects, there may be a single repeater, which may be an AP. As illustrated in example 540, in some aspects, there may be two repeaters, which may be an AP and an RP. As illustrated in example 550, in some aspects, there may be two repeaters, which may be an AP and a mixed type of repeater having AP and RP functionality (e.g., able to provide a local sub-THz coverage spot with an access link to a sub-THz eligible UE and to serve as an intermediate repeater to interconnect other repeater to the network entity).

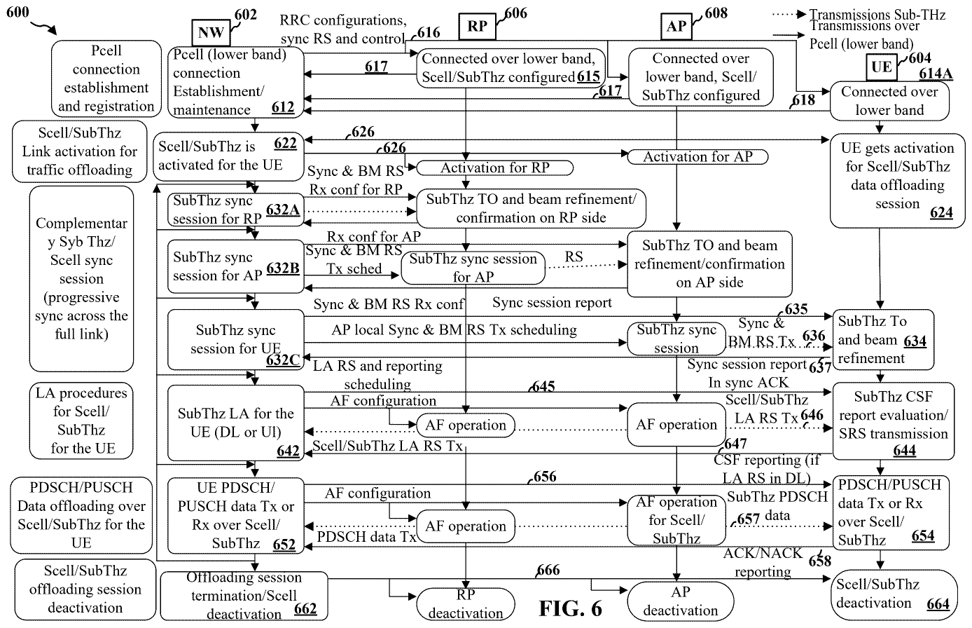

FIG. 6 is a diagram 600 illustrating example communications between a network entity 602 and a UE 604 via one or more repeaters, such as an RP 606 and an AP 608. In some aspects, the network entity may be a base station that may be implemented as an aggregated base station, as a disaggregated base station, an integrated access and backhaul (IAB) node, a relay node, a sidelink node, or the like. A network entity may be implemented in an aggregated or monolithic base station architecture, or alternatively, in a disaggregated base station architecture, and may include one or more of a CU, a DU, a RU, a Near-Real Time (Near-RT) RAN Intelligent Controller (RIC), or a Non-Real Time (Non-RT) RIC. In some aspects, the RP 606 and the AP 608 may be repeaters. In some aspects, the RP 606 and the AP 608 may be other types of repeaters, such as mixed type or the like.

As illustrated in FIG. 6, at 612, the network entity 602 may establish Pcell connection and maintenance for the UE 604. At a same time, at 614A, the UE 604 may be connecting to the Pcell, which may be of a lower frequency range than sub-THz communication. The UE 604 may be continuously connected to the Pcell.

The network entity 602 may transmit one or more RRC configurations, synchronization RS, and control information for Pcell link 616 to the UE 604, the RP 606, and the AP 608 over Pcell link. Based on the one or more RRC configurations, synchronization RS, and control information for Pcell link 616, the RP 606 may be registered and connected over Pcell. Based on the one or more RRC configurations, synchronization RS, and control information for Pcell link 616, the AP 608 may also be registered and connected over Pcell.

The UE 604 may transmit a UE capability indication 618 that may indicate a capability for sub-THz communication capability to the network entity over Pcell link. Based on the capability for sub-THz communication capability, the network entity 602 may configure (e.g., at a later time), sub-THz communication for the UE 604. As used herein, the term “UE capability indication” may refer to a message indicating one or more capabilities associated with a UE. The AP 608 may transmit repeater capability indication 615 to the network entity 602 over Pcell link and the RP 606 may transmit repeater capability indication 617 to the network entity 602 over Pcell link. The repeater capability indication 615 and the repeater capability indication 617 may indicate capability for serving as a repeater for sub-THz communication.

In some aspects, at a later time based on one or more conditions (e.g., when the UE 604 may be having a high data traffic and may be in coverage range of sub-THz NW entity transceiver), the network entity 602 may, at 622, activate the sub-THz communication for the UE 604 by transmitting an activation 626 to the UE 604, the AP 608, and the RP 606.

In some aspects, the one or more conditions may include that the UE 604 is in a sub-THz transceiver/network entity/small cell/IAB/Smart repeater coverage range. In some aspects, the network entity 602 may determine that the UE 604 is in a sub-THz transceiver/network entity/small cell/IAB/Smart repeater coverage range based on UE location information, sub-THz transceivers coverage zone/range information, range information associated with the RP 606 and the AP 608, and the repeater capability indication 615 and the repeater capability indication 617. In some aspects, the UE location information may be provided to/acquired by the network entity 602 based on the Pcell connectivity based on: (1) GPS information from the UE 604 reported or indicated to the network entity 602 based on Pcell or (2) UE location determined based on positioning procedures employed based on Pcell connectivity.

In some aspects, a repeater capability indication (e.g., 615 or 617) may indicate a quantity of different non-simultaneous connections with other repeaters or network entity that the repeater may support on a service link (e.g., with a child RP or AP that may facilitate connection to the UE) and on donor link (e.g., with the parent RP or AP that may facilitate connection to the network entity, or network entity). In some aspects, an AP may use an array-based beamformer with a wide angular span support and a flexible beam shaping ability (e.g., to be able to connect to a nomadic UE) while an RP may use lens-based beamformer with a smaller number of supported beams localized in a specific narrow angular sector (e.g., that may be configured by an installation targeting a fixed LOS link with an AP or a network entity). In some aspects, each repeater-to-repeater or repeater-to-network entity connection (fixed or LOS) may each be associated with a dedicated lens-based beamformer or a dedicated forwarding/transmission/reception ability to/from a corresponding direction/narrow spatial sector. In some aspects, the number of connections supported may be based on number of integrated lens beamformers on the repeater (e.g., so that each lens beamformer may be physically pointed to a configured direction or spatial sector).

In some aspects, the repeater capability indication (e.g., 615 or 617) may indicate a quantity of simultaneous connections that can be supported with other repeaters on service link side (towards the child RP/AP) from the repeater perspective which may allow support sub-THz UEs co-scheduling in UL (or in DL) via frequency division multiplexing (FDM). In some aspects, support of simultaneous connections with more than a single AP/RP may use replication of parts of RF chain hardware and processing in addition to lens beamformers replication. Support of the simultaneous connections may be based on signals combiner and splitter in additional to amplify and forward function part. In some aspects, partial RF chain replication (based on the number of supported simultaneous links) may be used for RF processing before the combining (e.g., for UL forwarding direction) or after the splitting (e.g., for DL forwarding direction). In some aspects, the combiner or splitter may be used on a mixed type repeater which may combine locally connected UE signal to signal simultaneously received from the previous node (in UL direction) or correspondingly split the DL signal into two replicas (one replicate to be forwarded to a locally connected UE and another replicate to be forwarded to the next node in DL direction).

In some aspects, the repeater capability indication (e.g., 615 or 617) may indicate a repeater type or other mesh related capabilities such as at least one of: maximum Tx power, EIRP or Tx power category (e.g., for estimating maximal link range) per supported parent/child node link, static or mobile repeater category (stationary or potentially moving). The repeater capability indication (e.g., 615 or 617) may also indicate repeater beam codebook related capabilities or information such as—beam width, number of beams it supports, spatial sector it can cover per every parent/child link, different lens beamformers boresight direction information (e.g., based on a unified azimuth/elevation reference coordinates system).

In some aspects, based on the repeater capability indication (e.g., 615 or 617) of each of the repeaters in the network, the network entity 602 may assess potentially possible connections at least in terms of sub-THz link range and determine a list of potential connection options. In some aspects, the network entity 602 may also use ray tracing to reduce the list of potential connection options.

In some aspects, the one or more conditions may include that the UE 604 may have a mobility smaller than a threshold. In some aspects, the mobility of the UE 604 may be determined based on Doppler measurements or reports from the UE 604 (based on Pcell connectivity), based on the UE 604's speed/mobility range information indicated by the UE 604 via Pcell, or may be based on UE location tracking based on Pcell positioning or UE GPS information reporting by the UE 604.

In some aspects, the one or more conditions may include that the UE 604 is sub-THz capable (e.g., based on the capability for sub-THz communication capability in the UE capability indication 618). In some aspects, the one or more conditions may include that the UE 604 have enough battery resource (which may be indicated by the UE 604 over Pcell). In some aspects, the one or more conditions may include that the UE 604 have a data volume potential or usage above a threshold. The data volume potential or usage for the UE 604 may be estimated based on UE Pcell link capacity/data volume, specific application activation, UE type and related services or data scheduling request/reservation for the UE in DL or UL directions. In some aspects, the UE location information, UE speed/mobility range and battery resource information can be indicated by the UE 604 via layer 3 (L3) signaling (e.g., as a part of UE Assistance Information (UAI) message).

Upon receiving the activation 626, at 624, the UE 604 may get activation for sub-THz communication on the Scell for data offloading via sub-THz. In some aspects, the sub-THz communication may carry one or more of the following transmissions (e.g., without other transmissions): (1) PDSCH/PUSCH data, (2) link adaptation (LA) resources (e.g., for LA including at least one of a rank indicator (RI), a precoding matrix indicator (PMI), a modulation and coding scheme (MCS), or a channel quality indicator (CQI) based on a CSI-RS or a SRS) for PDSCH/PUSCH LA procedures directly on sub-THz link, and (3) sub-THz local synchronization and beam management related RS transmissions to support complementary sub-THz time synchronization and BM sessions.

At 632A, 632B, and 632C, the network entity 602 may perform sub-THz synchronization and BM session for the UE 604, the RP 606, and the AP 608 (e.g., per sub-THz link/Scell the activation or based on semi-periodic or scheduled sessions along long lasting active link or session). In some aspects, coarse synchronization and beam/beam direction determination for sub-THz may be based on Pcell connectivity. A complementary time synchronization/refinement and sub-THz beam refinement/reduced scope beam search (e.g., including automatic gain control) procedures and related RS transmissions may be supported locally via sub-THz on the Scell. In some aspects, the sub-THz local synchronization and beam management related RS transmissions may include an aperiodic SSB mini burst or a dedicated synchronization RS and BM RS scheduling. In some aspects, customized SSB mini burst/synchronization and BM RS configuration for the RP 606 may be transmitted via the Pcell. One or more aperiodic customized SSB/synchronization and BM RS may be transmitted via the sub-THz connection on the Scell. In some aspects, local synchronization and beam management sessions may be based on a customized per transmission/UE/RP/AP dedicated RS (e.g., the one or more aperiodic customized SSB mini burst/synchronization and BM RS transmitted via the sub-THz connection on the Scell). In some aspects, upon receiving the one or more aperiodic customized SSB mini burst/synchronization and BM RS, the RP 606 may perform sub-THz complementary time synchronization and BM at 634. In some aspects, upon receiving the one or more aperiodic customized SSB/synchronization and BM RS, the RP 606 may transmit a synchronization (which may be also referred to as “sync”) report and a successful time synchronization and beam refinement acknowledgment (ACK) to the network entity 602. The ACK may be an “in sync” ACK associated with a flag representing in synchronization state on RP side for the sub-THz link. The sync report and ACK may be transmitted over the Pcell. Similarly, in some aspects, customized SSB mini burst/synchronization and BM RS configuration for the AP 608 may be transmitted via the Pcell. In some aspects, the dedicated RS may be not based on an SSB wave form. The SSB mini burst may be a SSB waveform (e.g., modified compared to a non-sub-THz SSB waveform). One or more aperiodic customized SSB mini burst/synchronization and BM RS may be transmitted via the sub-THz connection on the Scell and via the RP 606. In some aspects, local synchronization and beam management sessions may be based on a customized per transmission/UE/RP/AP dedicated RS (e.g., the one or more aperiodic customized SSB mini burst/synchronization and BM RS transmitted via the sub-THz connection on the Scell). In some aspects, upon receiving the one or more aperiodic customized SSB mini burst/synchronization and BM RS, the AP 608 may perform sub-THz complementary time synchronization and BM at 634. In some aspects, upon receiving the one or more aperiodic customized SSB/synchronization and BM RS, the AP 608 may transmit a synchronization (which may be also referred to as “sync”) report and a successful time synchronization and beam refinement acknowledgment (ACK) to the network entity 602. The ACK may be an “in sync” ACK associated with a flag representing in synchronization state on AP side for the Sub-THz link. The sync report and ACK may be transmitted over the Pcell.

In some aspects, customized SSB/synchronization and BM RS configuration 635 for the UE 604 may be transmitted via the Pcell. One or more aperiodic customized SSB mini burst/synchronization and BM RS 636 may be transmitted via the sub-THz connection on the Scell and via the RP 606 and the AP 608. In some aspects, local synchronization and beam management sessions may be based on a customized per transmission/UE/RP/AP dedicated RS (e.g., the one or more aperiodic customized SSB mini burst/synchronization and BM RS transmitted via the sub-THz connection on the Scell). In some aspects, upon receiving the one or more aperiodic customized SSB/synchronization and BM RS 636, the UE 604 may perform sub-THz complementary time synchronization and BM at 634. In some aspects, upon receiving the one or more aperiodic customized SSB mini burst/synchronization and BM RS 636, the UE 604 may transmit a BM report and a successful time synchronization and beam refinement acknowledgment (ACK) 637 to the network entity 602. The ACK may be an “in sync” ACK associated with a flag representing in synchronization state on UE side for the Sub-THz link. The BM report and ACK 637 may be transmitted over the Pcell.

In other words, the sync procedure may be progressive sync across the hops. At the first step, the nearest to network entity hop (e.g., RP 606) may get fully synchronized to the network entity 602 in terms of the RP local timing synchronization over sub-THz/Scell, RP UL timing synchronization over sub-THz/Scell (timing advance (TA) with respect to network entity), frequency sync over sub-THz/Scell (derived based on Pcell), sub-THz refined beam for the hop including Tx beam and Rx beam (RP) pair. Then the nearest to network entity repeater (e.g., RP 606) may become a reference point for timing synchronization for the next hop (e.g., AP 608) (it may carry out local sync RS transmissions aligned with its local Rx timing synchronization with respect to network entity/previous Tx node). At the next step, the next in DL direction hop (between RP 606 and AP 608, or the AP 608) may get its receiving edge/node (e.g., the AP 608) fully synchronized to its transmitting edge/node (e.g., the RP 606) in terms of its local timing synchronization over sub-THz/Scell, UL timing synchronization over sub-THz/Scell (TA with respect to the transmitting node/RP of this hop in DL direction), frequency sync over sub-THz/Scell (derived based on Pcell), sub-THz refined beam for this hop including Tx beam (for the RP 606) and Rx beam (AP) pair. Once this is done, the receiving node of this hop (e.g., the AP 608) may become a reference point for timing synchronization for the next hop (between the AP and a sub-THz eligible UE such as the UE 604). Correspondingly, once synchronized, it can carry out local sync RS transmissions aligned with its local Rx timing synchronization with respect to the previous Tx node (e.g., the RP 606). The same synchronization step may be done for the last sub-THz link hop between the AP and a sub-THz eligible UE such that the UE may be fully synchronized to the AP 608. Therefore, at the end of the synchronization procedure, every component/node of multi-hop link may be synchronized on its local Rx timing for sub-THz/Scell transmissions between the network entity 602 and the UE 604, and be frequency coherent over sub-THz/Scell and may be aware about the selected Tx and Rx beams pair per hop. In some aspects, hop specific sync & BM sessions that can be based on customized per hope and per session local sync RS/SSB mini burst transmission that may be scheduled for sub-THz and for different node. Local SSB/sync RS Tx/Rx capability may be present on each node (e.g., the RP 606, the AP 608, and the UE 604). In some aspects, configuration of the hop specific sync & BM session for the corresponding Tx and Rx sides/nodes may be provided by the network entity 602 over Pcell. There may be no dependency/associations between sync RS/SSB mini bursts transmitted on different hops, but there may be a sequential order. At the end of per hop sync & BM session, the receiving side of each hop will provide a synchronization related report to network entity over Pcell (e.g., BM report and “in sync” ACK flag). In some aspects, all the multi-hop link establishment procedures including progressive sync across hops are fully controlled by Pcell network entity (e.g., the network entity 602). All the involved repeaters may be fully transparent from the UE perspective.

At 642, sub-THz LA (e.g., DL or UL) for the UE 604 may be performed by the network entity 602. The network entity 602 may transmit one or more LA RS and reporting scheduling 645 for the UE 604 over the Pcell, via the RP 606 and the AP 608. The UE 604 may communicate one or more Scell sub-THz LA RS 646 with the network entity 602 based on the sub-THz communication and the Scell. At 644, based on the communicated Scell sub-THz LA RS 646, the UE 604 may perform channel state feedback (CSF) report evaluation or SRS transmission. The UE 604 may transmit associated CSF reporting 647 based on the Pcell. In some aspects, amplify and forward configurations for forwarding sub-THz communications may be provided to the RP 606 and the AP 608 by the network entity 602.

In some aspects, one or more procedures may not be supported over the sub-THz communication over the Scell. For example, in some aspects, RACH procedure and initial acquisition may not be supported over the sub-THz communication over the Scell (Scell connection establishment procedures are fully controlled and initiated by network entity and DL and UL complementary time synchronization and beam refinement for sub-THz can be done based on the configured, scheduled (over Pcell) for UE Rx and transmitted by the NW over sub-THz synchronization & BM session for the UE). In some aspects, there may be no “always on” transmissions over sub-THz (e.g., SSB). In some aspects, sub-THz UE may be continuously connected over Pcell and a Scell/sub-THz link may be activated over a session. Such a session may use a complementary synchronization and beam refinement sessions per activation (or per some time duration for long lasting active sub-THz links). In some aspects, sub-THz/Scell control plane (e.g., (UE RRC connection/registration, sub-THz offloading activation/deactivation, scheduling of BM/synchronization RS/LA RS, DL/UL scheduling, all sub-THz related feedback/reports) may be transmitted over the Pcell but not the Scell. In some aspects, beam failure detection (BFD) and radio link failure (RLF) procedures for sub-THz/Scell may be replaced by the “in sync” flag reported over the Pcell as a response to each sub-THz synchronization and BM session. If the “in sync” flag is not set (e.g., in the BM report and ACK 637), a sub-THz synchronization & BM session may be rescheduled by the network entity 602 and repeated with a modified configuration (beams list, time uncertainty boundaries, power level, or the like). Correspondingly, in some aspects, there may be no beam failure recovery (BFR) procedure for the sub-THz communication (since Pcell connectivity is preserved, synchronization and beam refinement sessions for sub-THz that can be triggered/rescheduled by gNB over Pcell). There may be sub-THz BM reports (e.g., 637) for several measured during synchronization and BM session sub-THz beams transmitted over the Pcell from the UE 604 to the network entity 602. In some aspects, a repeated/additional synchronization session may be scheduled as a response to a non-set “in sync” flag or based on another event. In some aspects, Scell activation or a dedicated customized synchronization and beam management session scheduling on sub-THz transceiver side (for transmission) to support Scell activation and sub-THz link establishment/synchronization session for a specific sub-THz eligible UE (e.g., the UE 604) may be controlled by an entity supporting the Pcell (e.g., a Pcell gNB). The corresponding sub-THz transceiver/gNB/small cell/IAB/Smart repeater to be employed for sub-THz link establishment for a specific sub-THz eligible UE (e.g., the UE 604) may be determined based on the UE location information (associated with the UE eligibility criteria (e.g., the one or more conditions) for dynamic Scell/sub-THz session activation).

At 652, the network entity 602 may perform PDSCH or PUSCH data transmission or reception over the Scell and the sub-THz communication. Correspondingly, at 654, the UE 604 may perform PDSCH or PUSCH data transmission or reception over the Scell and the sub-THz communication. The network entity 602 may transmit scheduling information 656 for the PDSCH or PUSCH data transmission over the Pcell. The PDSCH or PUSCH data 657 may be transmitted or received over the Scell and based on the sub-THz communication, via the RP 606 and the AP 608. The UE 604 may perform associated ACK or NACK reporting 658 based on the Pcell. As used herein, the term “scheduling information” may be used to refer to information regarding scheduled time and frequency resources for a PDSCH or a PUSCH, which may be carried by PDCCH.

At 662, the network entity 602 may terminate the sub-THz communication session and deactivate the Scell by transmitting a deactivation 666 to the UE 604, the AP 608, and the RP 606. Based on the deactivation 666, at 664, the UE 604 may terminate the sub-THz communication session and deactivate the Scell. The AP 608 and the RP 606 may also terminate the sub-THz communication session and deactivate the Scell based on the deactivation 666.

In some aspects, sub-THz/Scell synchronization and beam management procedures may be partially based on Pcell to allow a dynamic Scell activation/deactivation with a low latency, low complexity and low power penalties per activation. In some aspects, there may be no frequency tracking loop or frequency synchronization for the Scell and the sub-THz communication. In some aspects, frequency tracking or frequency synchronization for the Pcell may be reused for the Scell and the sub-THz communication. In some aspects, Pcell time tracking loop (TTL) and Pcell timing may be used as a coarse timing for the Scell and the sub-THz communication. In some aspects, no independent TTL may be employed on Scell and the sub-THz communication and there may be a complimentary fine timing estimation to derive a relative sub-THz link/Scell timing offset with respect to Pcell timing. In some aspects, coarse beam/beam direction for sub-THz/Scell may be determined based on Pcell beam associations or determined based on primary cell link channel and precoding information. Correspondingly, a reduced candidate beams list size and a reduced time uncertainty range for complementary synchronization session where session start time and duration may be indicated to refer to Pcell timing may be addressed per Scell/sub-THz link activation (e.g., beam refinement for sub-THz instead of a full scope beam search).

In some aspects, candidate or hypothetic link testing may be performed based on hop specific synchronization and BM sessions triggered or scheduled by a Pcell gNB (e.g., the network entity 602), which may have an extended beam sweeping scope during initial installation procedure of the one or more repeaters (e.g., AP 608 and RP 606). In some aspects, the hop specific synchronization and BM sessions may be based on a customized per hop and per session local aperiodic synchronization RS, SSB burst, or SSB mini burst transmission that may be scheduled over the sub-THz connection for the candidate or hypothetic link testing for one or more hops and for one or more involved repeaters. Local SSB or synchronization RS transmission and reception capability may be present per node (e.g., all repeaters including the AP 608 and the RP 606). During the hop specific synchronization and BM session, a corresponding hop specific synchronization and BM RS may be transmitted by a first hop edge (a parent node in the DL direction such as the RP 606) and received by the corresponding second hop edge (a child node in the DL direction such as the AP 608). Beam sweeping may be employed for Rx and Tx side beams and both nodes related to a specific tested hop. In some aspects, configuration(s) of the hop specific synchronization and BM session for the corresponding Tx and Rx nodes may be provided by the network entity 602 over Pcell. The multi hop candidate link testing may follow a progressive synchronization procedure where hops (e.g., each repeater) may be tested sequentially in downlink direction direction until the entire multi hop link may be established or one of the hops may fail the synchronization and beam management sessions.

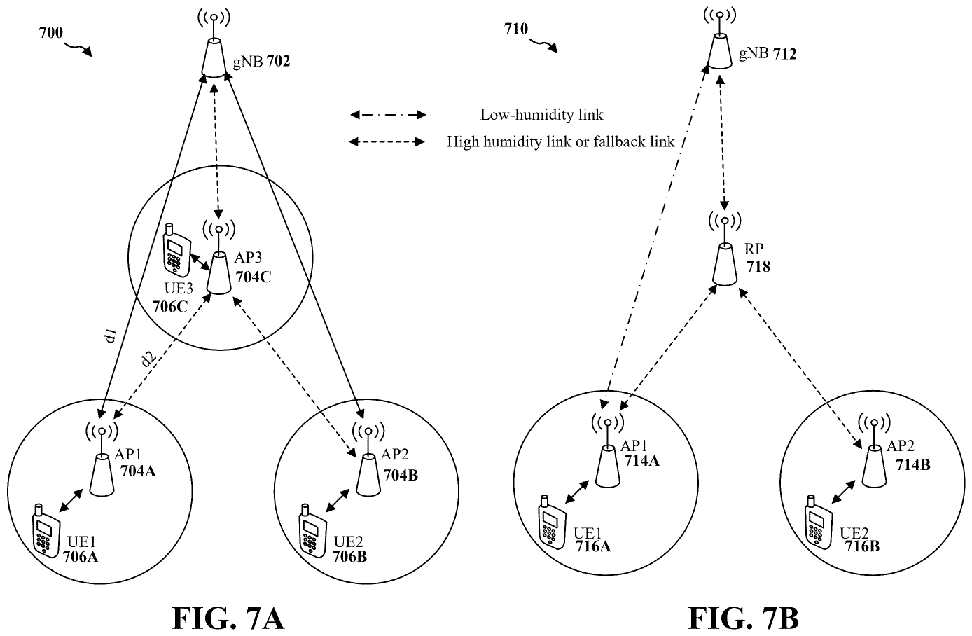

Correspondingly, a sub-THz repeater may be capable of transmitting a dedicated flexibly configurable (per synchronization and BM session) NB synchronization & BM RS (e.g., aperiodically transmitted dedicated waveform or SSB burst/mini burst) over sub-THz (e.g., to the next link node in DL direction) and receiving over sub-THz (from the previous link node in DL). In some aspects, there may be no dependency between synchronization RS/SSB bursts/SSB mini bursts transmitted on different hops (which may be aperiodic local transmissions, triggered by the network entity 602 with a customized per hop configuration which may depend among the rest on repeater related capabilities). The outcome of the hop specific synchronization and BM session (which may be used for hypothetical link validation) may be a BM report for the relevant tested hop that may be provided over Pcell to the network entity 602. The report may be provided by the receiving side node (from the synchronization and BM session) and may list several candidate beams for the tested connectivity hop/branch with the corresponding signal quality metric per beam (signal to interference and noise ratio (SINR), reference signal received power (RSRP), received signal strength indicator (RSSI), or the like). Based on the provided reports for different tested links, the network entity 602 may be able to select one or more alternative sub-THz link connection options (a mesh grid) per each installed/registered repeater (and may be aware about the best and several alternative beams per validated connection option). Every future activation of Scell/sub-THz link (e.g., for the UE 604 or any other UE in the corresponding AP coverage range) involving one of the registered sub-THz repeaters (e.g., the AP 608 and the RP 606) may be based on the list of several already known best performing beams per involved by the activated link hop/branch (a reduced beam list may be relevant for synchronization and BM sessions scheduled upon sub-THz link activation/any next BM session for a specific hop if the repeaters are static repeaters with LOS links). FIG. 7A is a diagram 700 illustrating example mesh network scenario of sub-THz deployment. In FIG. 7A, a network entity 702, UE 706A, UE 706B, UE 706C, AP 704A, AP 704B, and AP 704C are illustrated. There may be 3 relatively close but non overlapping sub-THz coverage spots provided by these APs/repeaters. Each one of them is provided by the corresponding AP (AP 704A, AP 704B, AP 704C) which may have a direct LOS connection with the network entity 702 (e.g., a sub-THz network entity which may be a gNB transceiver). Each of the AP 704A, the AP 704B, and the AP 704C may serve a different UE residing in its local coverage spot, such as the UE 706A, the UE 706B, and the UE 706C. These different UEs can get sub-THz/Scell activation or scheduling of data offloading over sub-THz simultaneously or at different times. In case that several sub-THz UEs (UE3 and UE1 or UE2) associated with different APs get UL data offloading sessions/sub-THz scheduling at the same time, aspects provided herein may enable network power/energy efficiency optimization. The AP 704C may have additional interconnection capability to AP 704A and AP 704B at least in UL direction (e.g., which be a “mixed” (AP and RP) smart repeater type which supports 2 UL interconnection with AP 704A and AP 704B) or may support mesh topology. In some aspects, interconnection capability to AP 704A and AP 704B in DL direction may be used for co-scheduling in DL. In some aspects, simultaneous or not simultaneous connection the AP 704A and the AP 704B may be present. The UE 706A or the UE 706B may be co-scheduled with the UE 706C and data communication for the UE 706A or the UE 706B and UE 706C may be multiplexed in frequency domain over sub-THz channel (e.g., less than a maximum sub-THz link capacity or bandwidth for two or more co-scheduled UEs). The AP 704A and the AP 704B may transmit sub-THz UL data (e.g., PUSCH) for the UE 706A or the UE 706B to the AP 704C instead of the network entity 702 (e.g., assuming d1>2d2, this may enable at least 6 dB less transmit power to be used on AP1/AP2 side). The AP 704C may transmit the sub-THz UL data (e.g., PUSCH) for the UE 706A or the UE 706B simultaneously with the co-scheduled in UL UE 706C to the network entity 702 (e.g., assuming they have the same allocation BW, this may cause a 3 dB more transmit power to be used on the AP3 side, resulting in an overall 3 dB transmit power saving across the involved APs for UL data communication for co-scheduled sub-THz UEs).

FIG. 7B is a diagram 710 illustrating example mesh network scenario of sub-THz deployment. In FIG. 7B, a network entity 712, UE 716A, UE 716B, RP 718, AP 714A, and AP 714B are illustrated. As illustrated in FIG. 7B, dynamic multi hop link establishment/trajectory may be a function of humidity. For example, second hop activation for AP 714A connection to the network entity 712 may be done to address a high humidity conditions (heavy rain/snow/fog) which may result in a dramatic reduction of the typical Sub-THz link range or overall propagation attenuation (e.g., can be more than 20 dB attenuation difference depending on humidity conditions/rain fade for high frequencies). This multi hop connection may be used for a relatively small percentage of time per year and may be not used as a primary link for the AP 714A. For low humidity conditions, a direct link between the AP 714A and the network entity 712 may be used. Direct link may be more power efficient because average path loss (PL) model can be represented as a sum of two terms where the first term does not depend on the distance and can be interpreted as a kind of fixed penalty per Tx node (for d>1 meter):

$$P L = 10 {{log}_{10} ( \frac{4 π {d}_{0}}{λ} )}^{2} + 10 {{log}_{10} ( \frac{d}{{d}_{0}} )}^{n} ,$$

d₀=1[m], n>1, where d may be the propagation length, A may be the wavelength, and n may be PL model parameter depending on channel type and frequency. The RP 718 may be installed primarily to serve AP 714B's connection to the network entity 712, but may be used for AP 714A's connection if it has a LOS with AP 714A. Correspondingly, the RP 718 may be shared between AP 714A and AP 714B at different or same times (depending on RP718 hardware capabilities). Every sub-THz link may have a burst activity pattern with a dynamic activation/deactivation, which may allow sharing of some infrastructure components with a dynamic link establishment. As another example, in FIG. 7B, two interconnection trajectories may be used for improving robustness to blockage of one of the hops. For example, if LOS is blocked between the AP 714A and the network entity 712, the RP 718 may provide an alternative connection to the network entity 712 for the AP 714A.

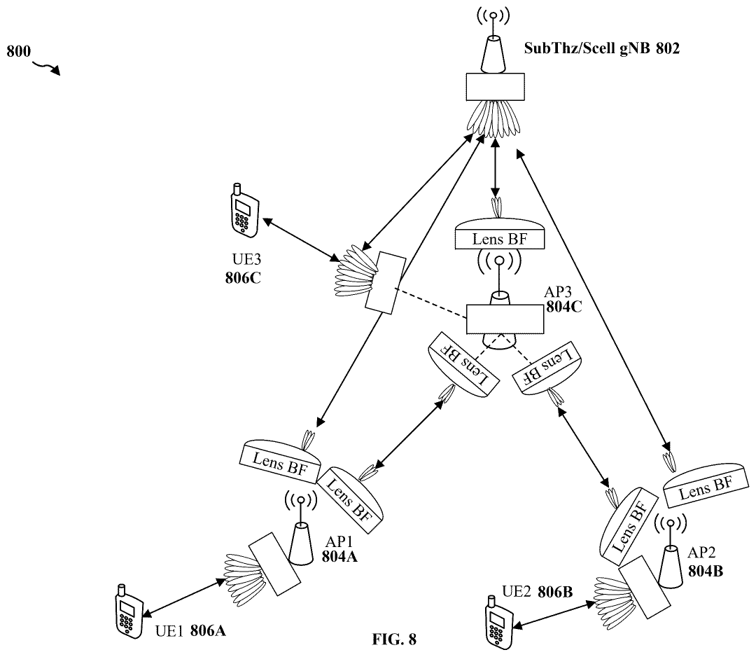

FIG. 8 is a diagram 800 illustrating example mesh network scenario of sub-THz deployment. In FIG. 8, a network entity 802, UE 806A, UE 806B, UE 806C, AP 804A, AP 804B, and AP 804C are illustrated. As illustrated in FIG. 8, as previously described, a capability indication may indicate a quantity of simultaneous connections that can be supported with other repeaters on access link side (towards the child RP/AP) from the repeater perspective which may allow support UE co-scheduling in UL (or in DL) via frequency division multiplexing (FDM) for UEs associated with different sub-THz coverage spots. In some aspects, support of simultaneous connections between the addressed repeater and more than a single other AP/RP may use replication of parts of RF chain hardware and processing in addition to lens beamformers replication. Support of the simultaneous connections on AP 804C side may be based on signals combiner and splitter (e.g., AP 804A, AP 804B simultaneously connected with AP 804C) in additional to amplify and forward function part. In some aspects, partial RF chain replication (based on the number of supported simultaneous links) may be used for RF processing before the combining (e.g., for UL forwarding direction) or after the splitting (e.g., for DL forwarding direction). In some aspects, the combiner or splitter may be used on a mixed type repeater which may combine locally connected UE signal to signal simultaneously received from the previous node (in UL direction) or correspondingly split the DL signal into two replicas (one replicate to be forwarded to a locally connected UE and another replicate to be forwarded to the next node in DL direction). This scenario may be relevant in case of co-scheduling of different sub-THz UEs associated with different sub-THz coverage spots.

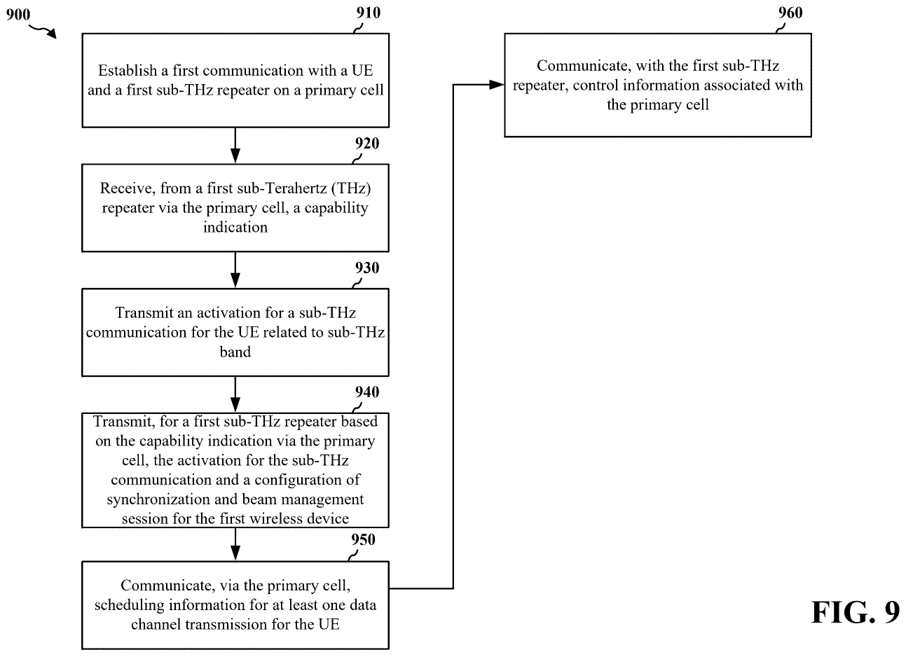

FIG. 9 is a flowchart 900 of a method of wireless communication. The method may be performed by a network entity (e.g., the base station 102, the network entity 602, the network entity 1102).

At 910, the network entity may establish a first communication with a UE on a primary cell. For example, the network entity 602 may establish a first communication (e.g., at 612) with a UE 604 on a primary cell. In some aspects, 910 may be performed by the communication component 199.

At 920, the network entity may receive, from a first sub-THz repeater via the primary cell, a capability indication related to a sub-THz band. For example, the network entity 602 may receive, from a first sub-THz repeater via the primary cell, a capability indication (e.g., 615) related to a sub-THz band. In some aspects, 920 may be performed by the communication component 199. In some aspects, the capability indication indicates a quantity of different non-simultaneous connections associated with different spatial directions or at least non-fully overlapping spatial ranges supported by the first sub-THz repeater. In some aspects, each connection of the different non-simultaneous connections is associated with a dedicated transmission or reception unit with a spatial filter at the first sub-THz repeater. In some aspects, the dedicated transmission or reception unit with the spatial filter is a dedicated lens-based beamformer, and where the dedicated lens-based beamformer points to a spatial direction associated with the dedicated lens-based beamformer or covers a spatial range associated with the dedicated lens-based beamformer. In some aspects, the capability indication further includes at least one of: a repeater type associated with the first sub-THz repeater, at least one transmit power, at least one transmit power category or at least one effective isotropic radiate power (EIRP) associated with at least one connection associated with the first sub-THz repeater, spatial coverage information for at least one spatial sector associated with at least one connection; a mobility type associated with the first sub-THz repeater, or a set of repeater spatial filter codebook capabilities associated with the first sub-THz repeater. In some aspects, the set of repeater spatial filter codebook capabilities associated with the first sub-THz repeater includes one or more of: a supported beam width, a supported quantity of spatial filters, or a boresight direction information associated with the dedicated transmission or reception unit for the spatial filter at the first sub-THz repeater. In some aspects, the capability indication indicates a quantity of simultaneous connections supported by the first sub-THz repeater. In some aspects, the simultaneous connections are configured to be supported by a signal combiner or a signal splitter at the first sub-THz repeater. In some aspects, the simultaneous connections include a first connection for communicating directly with the UE or a second wireless device and a second connection for communicating directly with the network entity or a third wireless device. In some aspects, the first sub-THz repeater is selected based on the capability indication from a set of candidate wireless devices. For example, the network entity may determine a set of candidate wireless devices upon initial connection with each wireless device of the set of candidate wireless devices based on respective location information and respective capability indication associated with each wireless device of the set of candidate wireless devices, test, based on synchronization and beam management session for a first wireless device of the set of candidate wireless devices and configure synchronization and beam management session associated with at least one additional wireless device of the set of candidate wireless devices, a set of connection links associated with the set of candidate wireless devices, and select the at least one sub-THz repeater from the set of candidate wireless devices based on the test.

In some aspects, the first sub-THz repeater has a line-of-sight (LOS) connection with the network entity or with a second wireless device involved in the sub-THz communication associated with the UE. In some aspects, the capability indication is included in control information signaled over the primary cell. In some aspects, the control information further includes at least one of: a radio resource control (RRC) configuration determined by the network entity based on the capability indication, or repeater location information associated with the first sub-THz repeater.

At 930, the network entity may transmit an activation for the sub-THz communication for the UE. For example, the network entity 602 may transmit an activation (e.g., 626) for the sub-THz communication for the UE. In some aspects, 930 may be performed by the communication component 199.

At 940, the network entity may transmit, for the first sub-THz repeater based on the capability indication, the activation for the sub-THz communication and at least one configuration of synchronization and beam management session for the first sub-THz repeater. For example, the network entity 602 may transmit, for the first sub-THz repeater (e.g., RP 606) based on the capability indication, the activation (e.g., 626) for the sub-THz communication and at least one configuration of synchronization and beam management session for the first sub-THz repeater. In some aspects, 740 may be performed by the communication component 199.

At 950, the network entity may communicate, via the primary cell, scheduling information for at least one data channel transmission over the sub-THz band for the UE. For example, the network entity 602 may communicate, via the primary cell, scheduling information (e.g., 656) for at least one data channel transmission over the sub-THz band for the UE. In some aspects, 750 may be performed by the communication component 199.

At 960, the network entity may communicate, via the first sub-THz repeater and the sub-THz communication, the at least one data channel transmission for the UE. For example, the network entity 602 may communicate, via the first sub-THz repeater (e.g., RP 606) and the sub-THz communication, the at least one data channel transmission (e.g., 657) for the UE. In some aspects, 760 may be performed by the communication component 199.

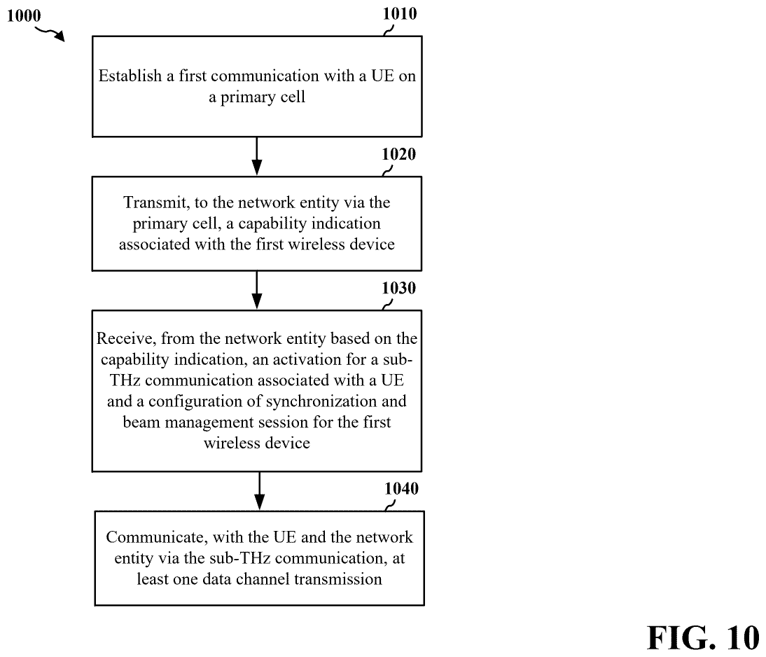

FIG. 10 is a flowchart 1000 of a method of wireless communication. The method may be performed by a first wireless device (e.g., the RP 606, the AP 608, the network entity 1260).

At 1010, the first wireless device may establish a first communication with a network entity on a primary cell. For example, the RP 606 may establish a first communication with a network entity 602 on a primary cell. In some aspects, 1010 may be performed by the communication component 199.

At 1020, the first wireless device may transmit, to the network entity via the primary cell, a capability indication associated with the first wireless device. For example, the RP 606 may transmit, to the network entity via the primary cell, a capability indication (e.g., 615) associated with the first wireless device. In some aspects, 1010 may be performed by the communication component 199. In some aspects, the capability indication indicates a quantity of different non-simultaneous connections associated with different spatial directions or at least non-fully overlapping spatial ranges supported by the first sub-THz repeater. In some aspects, each connection of the different non-simultaneous connections is associated with a dedicated transmission or reception unit with a spatial filter at the first sub-THz repeater. In some aspects, the dedicated transmission or reception unit with the spatial filter is a dedicated lens-based beamformer, and where the dedicated lens-based beamformer points to a spatial direction associated with the dedicated lens-based beamformer or covers a spatial range associated with the dedicated lens-based beamformer. In some aspects, the capability indication further includes at least one of: a repeater type associated with the first sub-THz repeater, at least one transmit power, at least one transmit power category or at least one effective isotropic radiate power (EIRP) associated with at least one connection associated with the first sub-THz repeater, spatial coverage information for at least one spatial sector associated with at least one connection; a mobility type associated with the first sub-THz repeater, or a set of repeater spatial filter codebook capabilities associated with the first sub-THz repeater. In some aspects, the set of repeater spatial filter codebook capabilities associated with the first sub-THz repeater includes one or more of: a supported beam width, a supported quantity of spatial filters, or a boresight direction information associated with the dedicated transmission or reception unit for the spatial filter at the first sub-THz repeater. In some aspects, the capability indication indicates a quantity of simultaneous connections supported by the first sub-THz repeater. In some aspects, the simultaneous connections are configured to be supported by a signal combiner or a signal splitter at the first sub-THz repeater. In some aspects, the simultaneous connections include a first connection for communicating directly with the UE or a second wireless device and a second connection for communicating directly with the network entity or a third wireless device. In some aspects, the first sub-THz repeater is selected based on the capability indication from a set of candidate wireless devices. For example, the network entity may determine a set of candidate wireless devices upon initial connection with each wireless device of the set of candidate wireless devices based on respective location information and respective capability indication associated with each wireless device of the set of candidate wireless devices, based on synchronization and beam management session for a first wireless device of the set of candidate wireless devices and configure synchronization and beam management session associated with at least one additional wireless device of the set of candidate wireless devices, a set of connection links associated with the set of candidate wireless devices, and select the at least one sub-THz repeater from the set of candidate wireless devices based on the test.

In some aspects, the first sub-THz repeater has a line-of-sight (LOS) connection with the network entity or with a second wireless device involved in the sub-THz communication associated with the UE. In some aspects, the capability indication is included in control information signaled over the primary cell. In some aspects, the control information further includes at least one of: a radio resource control (RRC) configuration determined by the network entity based on the capability indication, or repeater location information associated with the first sub-THz repeater.

At 1030, the first wireless device may receive, from the network entity based on the capability indication via the primary cell, an activation for a sub-THz communication associated with a UE and a configuration of a synchronization and beam management session for the first wireless device, the sub-THz communication being on a first frequency range that does not include a second frequency of the first communication. For example, the RP 606 may receive, from the network entity based on the capability indication, an activation (e.g., 626) for a sub-THz communication associated with a UE and a configuration of a synchronization and beam management session for the first wireless device, the sub-THz communication being on a first frequency range that does not include a second frequency of the first communication. In some aspects, 1030 may be performed by the communication component 199.

At 1040, the first wireless device may communicate, with the UE and the network entity via the sub-THz communication, at least one data channel transmission. For example, the RP 606 may communicate, with the UE and the network entity via the sub-THz communication, at least one data channel transmission (e.g., 657). In some aspects, 1040 may be performed by the communication component 199. In some aspects, the at least one data channel transmission includes at least one of: a physical downlink shared channel (PDSCH) transmission or a physical uplink shared channel (PUSCH) transmission. In some aspects, scheduling information for the at least one data channel transmission is communicated via at least one of: a physical downlink control channel (PDCCH) or a physical uplink control channel (PUCCH). In some aspects, the sub-THz communication does not include control channel communication.

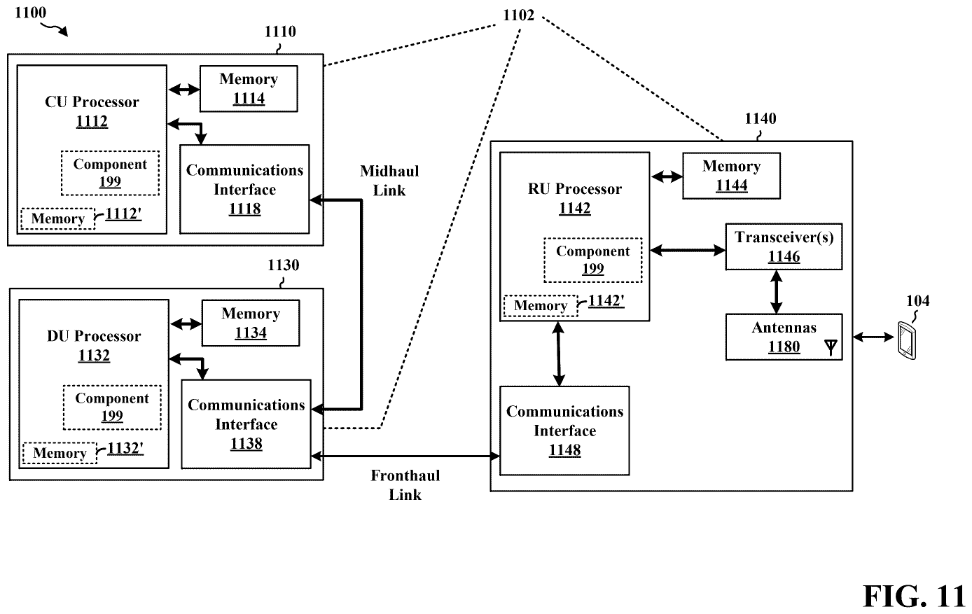

FIG. 11 is a diagram 1100 illustrating an example of a hardware implementation for a network entity 1102. The network entity 1102 may be a BS, a component of a BS, or may implement BS functionality. The network entity 1102 may include at least one of a CU 1110, a DU 1130, or an RU 1140. For example, depending on the layer functionality handled by the component 199, the network entity 1102 may include the CU 1110; both the CU 1110 and the DU 1130; each of the CU 1110, the DU 1130, and the RU 1140; the DU 1130; both the DU 1130 and the RU 1140; or the RU 1140. The CU 1110 may include a CU processor 1112. The CU processor 1112 may include on-chip memory 1112′. In some aspects, the CU 1110 may further include additional memory modules 1114 and a communications interface 1118. The CU 1110 communicates with the DU 1130 through a midhaul link, such as an F1 interface. The DU 1130 may include a DU processor 1132. The DU processor 1132 may include on-chip memory 1132′. In some aspects, the DU 1130 may further include additional memory modules 1134 and a communications interface 1138. The DU 1130 communicates with the RU 1140 through a fronthaul link. The RU 1140 may include an RU processor 1142. The RU processor 1142 may include on-chip memory 1142′. In some aspects, the RU 1140 may further include additional memory modules 1144, one or more transceivers 1146, antennas 1180, and a communications interface 1148. The RU 1140 communicates with the UE 104. The on-chip memory 1112′, 1132′, 1142′ and the additional memory modules 1114, 1134, 1144 may each be considered a computer-readable medium/memory. Each computer-readable medium/memory may be non-transitory. Each of the processors 1112, 1132, 1142 is responsible for general processing, including the execution of software stored on the computer-readable medium/memory. The software, when executed by the corresponding processor(s) causes the processor(s) to perform the various functions described herein. The computer-readable medium/memory may also be used for storing data that is manipulated by the processor(s) when executing software.

As discussed herein, the communication component 199 may be configured to the communication component 199 may be configured to establish a first communication with a UE and a first sub-THz repeater on a primary cell. In some aspects, the communication component 199 may be configured to receive, from a first sub-THz repeater via the primary cell, a capability indication related to a sub-THz band. In some aspects, the communication component 199 may be configured to transmit an activation for a sub-THz communication for the UE and a configuration of a synchronization and beam management session for the first sub-THz repeater, the sub-THz communication being on a first frequency range that does not include a second frequency of the first communication. In some aspects, the communication component 199 may be configured to transmit, for the first sub-THz repeater based on the capability indication, the activation for the sub-THz communication. In some aspects, the communication component 199 may be configured to communicate, via the primary cell, scheduling information for at least one data channel transmission over the sub-THz band for the UE. In some aspects, the communication component 199 may be configured to communicate, via the first sub-THz repeater and the sub-THz communication, the at least one data channel transmission for the UE. The communication component 199 may be within one or more processors of one or more of the CU 1110, DU 1130, and the RU 1140. The communication component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1102 may include a variety of components configured for various functions. In one configuration, the network entity 1102 includes means for establishing a first communication with a UE and a first sub-THz repeater on a primary cell. In some aspects, the network entity 1102 may further include means for receiving, from the first sub-THz repeater via the primary cell, a capability indication related to a sub-THz band. In some aspects, the network entity 1102 may further include means for transmitting an activation for a sub-THz communication for the UE, the sub-THz communication being on a first frequency range that does not include a second frequency of the first communication. In some aspects, the network entity 1102 may further include means for transmitting, for the first sub-THz repeater based on the capability indication via the primary cell, the activation for the sub-THz communication and at least one configuration of synchronization and beam management session for the first sub-THz repeater. In some aspects, the network entity 1102 may further include means for communicating, via the primary cell, scheduling information for at least one data channel transmission over the sub-THz band for the UE. In some aspects, the network entity 1102 may further include means for communicating, via the first sub-THz repeater and the sub-THz communication, the at least one data channel transmission for the UE. In some aspects, the network entity 1102 may further include means for determining a set of candidate wireless devices upon initial connection with each wireless device of the set of candidate wireless devices based on respective location information and respective capability indication associated with each wireless device of the set of candidate wireless devices. In some aspects, the network entity 1102 may further include means for testing, based on synchronization with a first wireless device of the set of candidate wireless devices and configure synchronization associated with at least one additional wireless device of the set of candidate wireless devices, a set of connection links associated with the set of candidate wireless devices. In some aspects, the network entity 1102 may further include means for selecting the at least one sub-THz repeater from the set of candidate wireless devices based on the test. The means may be the communication component 199 of the network entity 1102 configured to perform the functions recited by the means. As described herein, the network entity 1102 may include the TX processor 316, the RX processor 370, and the controller/processor 375. As such, in one configuration, the means may be the TX processor 316, the RX processor 370, and/or the controller/processor 375 configured to perform the functions recited by the means.

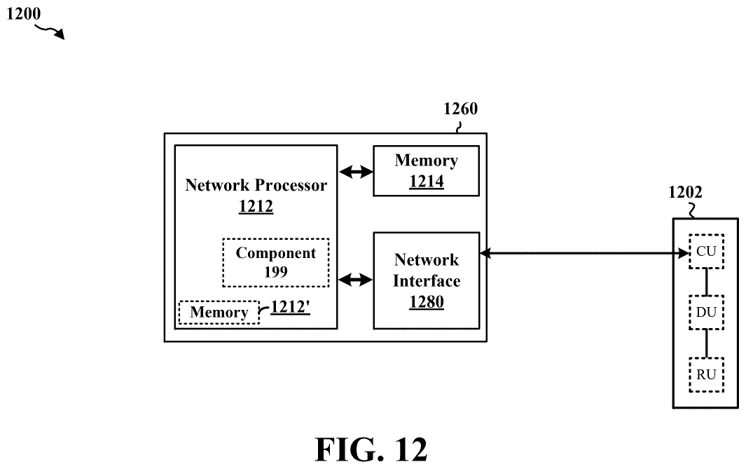

FIG. 12 is a diagram 1200 illustrating an example of a hardware implementation for a network entity 1260. In one example, the network entity 1260 may be within the core network 120. The network entity 1260 may include a network processor 1212. The network processor 1212 may include on-chip memory 1212′. In some aspects, the network entity 1260 may further include additional memory modules 1214. The network entity 1260 communicates via the network interface 1280 directly (e.g., backhaul link) or indirectly (e.g., through a RIC) with the CU 1202. The on-chip memory 1212′ and the additional memory modules 1214 may each be considered a computer-readable medium/memory. Each computer-readable medium/memory may be non-transitory. The processor 1212 is responsible for general processing, including the execution of software stored on the computer-readable medium/memory. The software, when executed by the corresponding processor(s) causes the processor(s) to perform the various functions described herein. The computer-readable medium/memory may also be used for storing data that is manipulated by the processor(s) when executing software.

As discussed herein, in some aspects, the communication component 199 may be configured to establish a first communication with a network entity on a primary cell. In some aspects, the communication component 199 may be configured to transmit, to the network entity via the primary cell, a capability indication associated with the first wireless device. In some aspects, the communication component 199 may be configured to receive, from the network entity based on the capability indication via the primary cell, an activation for a sub-THz communication associated with a UE and a configuration of a synchronization and beam management session for the first wireless device, the sub-THz communication being on a first frequency range that does not include a second frequency of the first communication. In some aspects, the communication component 199 may be configured to communicate, with the UE and the network entity via the sub-THz communication, at least one data channel transmission. The component 199 may be within the processor 1212. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1260 may include a variety of components configured for various functions. In one configuration, the network entity 1260 includes means for establishing a first communication with a network entity on a primary cell. In some aspects, the network entity 1260 may include means for transmitting, to the network entity via the primary cell, a capability indication associated with the first wireless device. In some aspects, the network entity 1260 may include means for receiving, from the network entity based on the capability indication via the primary cell, an activation for a sub-THz communication associated with a UE and a configuration of a synchronization and beam management session for the first wireless device, the sub-THz communication being on a first frequency range that does not include a second frequency of the first communication. In some aspects, the network entity 1260 may include means for communicating, with the UE and the network entity via the sub-THz communication, at least one data channel transmission. The means may be the component 199 of the network entity 1260 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for wireless communication at a first wireless device, comprising: a memory; and at least one processor coupled to the memory and, based at least in part on information stored in the memory, the at least one processor is configured to: establish a first communication with a network entity on a primary cell; transmit, to the network entity via the primary cell, a capability indication associated with the first wireless device; receive, from the network entity based on the capability indication via the primary cell, an activation for a sub-THz communication associated with a user equipment (UE) and a configuration of a synchronization and beam management session for the first wireless device, the sub-THz communication being on a first frequency range that does not include a second frequency of the first communication; and communicate, with the UE and the network entity via the sub-THz communication, at least one data channel transmission.

Aspect 2 is the apparatus of aspect 1, wherein the first wireless device is a first sub-THz repeater, and wherein the capability indication indicates a quantity of different non-simultaneous connections associated with different spatial directions or non-fully overlapping spatial ranges supported by the first wireless device.

Aspect 3 is the apparatus of any of aspects 1-2, wherein each connection of the different non-simultaneous connections is associated with a dedicated transmission or reception unit with a spatial filter at the first sub-THz repeater.

Aspect 4 is the apparatus of any of aspects 1-3, wherein the dedicated transmission or reception unit with the spatial filter is a dedicated lens-based beamformer, and wherein the dedicated lens-based beamformer points to a spatial direction associated with the dedicated lens-based beamformer or covers a spatial range associated with the dedicated lens-based beamformer.

Aspect 5 is the apparatus of any of aspects 1-4, wherein the capability indication further comprises at least one of: a repeater type associated with the first sub-THz repeater, at least one transmit power, at least one transmit power category or at least one effective isotropic radiate power (EIRP) associated with at least one connection associated with the first sub-THz repeater, spatial coverage information for at least one spatial sector associated with at least one connection; a mobility type associated with the first sub-THz repeater, or a set of repeater spatial filter codebook capabilities associated with the first sub-THz repeater.

Aspect 6 is the apparatus of any of aspects 1-5, wherein the set of repeater spatial filter codebook capabilities associated with the first sub-THz repeater comprises one or more of: a supported beam width, a supported quantity of spatial filters, or a boresight direction information associated with the dedicated transmission or reception unit for the spatial filter at the first sub-THz repeater.

Aspect 7 is the apparatus of any of aspects 1-6, wherein the first wireless device is a first sub-THz repeater, and wherein the capability indication further indicates a quantity of simultaneous connections supported by the first sub-THz repeater.

Aspect 8 is the apparatus of any of aspects 1-7, wherein the simultaneous connections are configured to be supported by a signal combiner or a signal splitter at the first sub-THz repeater.

Aspect 9 is the apparatus of any of aspects 1-8, wherein the simultaneous connections comprise a first connection for communicating directly with the UE or a second wireless device and a second connection for communicating directly with the network entity or a third wireless device.

Aspect 10 is the apparatus of any of aspects 1-9, wherein the first wireless device is selected based on the capability indication from a set of candidate wireless devices and based on one or more synchronization and beam management sessions with a second wireless device or the network entity.

Aspect 11 is the apparatus of any of aspects 1-10, wherein the first wireless device has a line-of-sight (LOS) connection with the network entity or with a second wireless device involved in the sub-THz communication associated with the UE.

Aspect 12 is the apparatus of any of aspects 1-11, wherein the capability indication is included in control information signaled over the primary cell.

Aspect 13 is the apparatus of any of aspects 1-12, wherein the first wireless device is a first sub-THz repeater, and wherein the control information further comprises at least one of: a radio resource control (RRC) configuration associated with the capability indication, or repeater location information associated with the first sub-THz repeater.

Aspect 14 is the apparatus of any of aspects 1-13, wherein the first wireless device has a direct link with the network entity, a direct link with the UE, or two direct links with two different wireless devices.

Aspect 15 is an apparatus for wireless communication at a network entity, comprising: a memory; and at least one processor coupled to the memory and, based at least in part on information stored in the memory, the at least one processor is configured to: establish a first communication with a user equipment (UE) and a first sub-THz repeater on a primary cell; receive, from the first sub-THz repeater via the primary cell, a capability indication related to a sub-THz band; transmit an activation for a sub-THz communication for the UE, the sub-THz communication being on a first frequency range that does not include a second frequency of the first communication; transmit, for the first sub-THz repeater based on the capability indication via the primary cell, the activation for the sub-THz communication and at least one configuration of synchronization and beam management session for the first sub-THz repeater; communicate, via the primary cell, scheduling information for at least one data channel transmission over the sub-THz band for the UE; and communicate, via the first sub-THz repeater and the sub-THz communication, the at least one data channel transmission for the UE.

Aspect 16 is the apparatus of aspect 15, wherein the capability indication indicates a quantity of different non-simultaneous connections associated with different spatial directions or at least non-fully overlapping spatial ranges supported by the first sub-THz repeater.

Aspect 17 is the apparatus of any of aspects 15-16, wherein each connection of the different non-simultaneous connections is associated with a dedicated transmission or reception unit with a spatial filter at the first sub-THz repeater.

Aspect 18 is the apparatus of any of aspects 15-17, wherein the dedicated transmission or reception unit with the spatial filter is a dedicated lens-based beamformer, and wherein the dedicated lens-based beamformer points to a spatial direction associated with the dedicated lens-based beamformer or covers a spatial range associated with the dedicated lens-based beamformer.

Aspect 19 is the apparatus of any of aspects 15-18, wherein the capability indication further comprises at least one of: a repeater type associated with the first sub-THz repeater, at least one transmit power, at least one transmit power category or at least one effective isotropic radiate power (EIRP) associated with at least one connection associated with the first sub-THz repeater, spatial coverage information for at least one spatial sector associated with at least one connection; a mobility type associated with the first sub-THz repeater, or a set of repeater spatial filter codebook capabilities associated with the first sub-THz repeater.

Aspect 20 is the apparatus of any of aspects 15-19, wherein the set of repeater spatial filter codebook capabilities associated with the first sub-THz repeater comprises one or more of: a supported beam width, a supported quantity of spatial filters, or a boresight direction information associated with the dedicated transmission or reception unit for the spatial filter at the first sub-THz repeater.

Aspect 21 is the apparatus of any of aspects 15-20, wherein the capability indication further indicates a quantity of simultaneous connections supported by the first sub-THz repeater.

Aspect 22 is the apparatus of any of aspects 15-21, wherein the simultaneous connections are configured to be supported by a signal combiner or a signal splitter at the first sub-THz repeater.

Aspect 23 is the apparatus of any of aspects 15-22, wherein the simultaneous connections comprise a first connection for communicating directly with the UE or a second wireless device and a second connection for communicating directly with the network entity or a third wireless device.

Aspect 24 is the apparatus of any of aspects 15-23, wherein the at least one processor is further configured to: determine a set of candidate wireless devices upon initial connection with each wireless device of the set of candidate wireless devices based on respective location information and respective capability indication associated with each wireless device of the set of candidate wireless devices; test, based on synchronization and beam management session for a first wireless device of the set of candidate wireless devices and configure synchronization and beam management session associated with at least one additional wireless device of the set of candidate wireless devices, a set of connection links associated with the set of candidate wireless devices; and select the at least one sub-THz repeater from the set of candidate wireless devices based on the test.

Aspect 25 is the apparatus of any of aspects 15-24, wherein the first sub-THz repeater has a line-of-sight (LOS) connection with the network entity or with a second wireless device involved in the sub-THz communication associated with the UE.

Aspect 26 is the apparatus of any of aspects 15-25, wherein the capability indication is included in control information signaled over the primary cell.

Aspect 27 is the apparatus of any of aspects 15-26, and wherein the control information further comprises at least one of: a radio resource control (RRC) configuration determined by the network entity at least in part on the capability indication, or repeater location information associated with the first sub-THz repeater.

Aspect 28 is the apparatus of any of aspects 15-27, wherein the first sub-THz repeater has a direct link with the network entity, a direct link with the UE, or two direct links with two different wireless devices.

Aspect 29 is a method of wireless communication for implementing any of aspects 1 to 14.

Aspect 30 is an apparatus for wireless communication including means for implementing any of aspects 1 to 14.

Aspect 31 is a computer-readable medium storing computer executable code, where the code when executed by a processor causes the processor to implement any of aspects 1 to 14.

Aspect 32 is a method of wireless communication for implementing any of aspects 15 to 28.

Aspect 33 is an apparatus for wireless communication including means for implementing any of aspects 15 to 28.

Aspect 34 is a computer-readable medium storing computer executable code, where the code when executed by a processor causes the processor to implement any of aspects 15 to 28.

What is claimed is:

1. An apparatus for wireless communication at a first wireless device, comprising:
a memory; and
at least one processor coupled to the memory and, based at least in part on information stored in the memory, the at least one processor is configured to:
establish a first communication with a network entity on a primary cell;
transmit, to the network entity via the primary cell, a capability indication associated with the first wireless device;
receive, from the network entity based on the capability indication via the primary cell, an activation for a sub-Terahertz (THz) communication associated with a user equipment (UE) and a configuration of a synchronization and beam management session for the first wireless device, the sub-THz communication being on a first frequency range that does not include a second frequency of the first communication; and
communicate, with the UE and the network entity via the sub-THz communication, at least one data channel transmission.

2. The apparatus of claim 1, wherein the first wireless device is a first sub-THz repeater, and wherein the capability indication indicates a quantity of different non-simultaneous connections associated with different spatial directions or non-fully overlapping spatial ranges supported by the first wireless device.

3. The apparatus of claim 2, wherein each connection of the different non-simultaneous connections is associated with a dedicated transmission or reception unit with a spatial filter at the first sub-THz repeater.

4. The apparatus of claim 3, wherein the dedicated transmission or reception unit with the spatial filter is a dedicated lens-based beamformer, and wherein the dedicated lens-based beamformer points to a spatial direction associated with the dedicated lens-based beamformer or covers a spatial range associated with the dedicated lens-based beamformer.

5. The apparatus of claim 3, wherein the capability indication further comprises at least one of: a repeater type associated with the first sub-THz repeater, at least one transmit power, at least one transmit power category or at least one effective isotropic radiate power (EIRP) associated with at least one connection associated with the first sub-THz repeater, spatial coverage information for at least one spatial sector associated with the at least one connection; a mobility type associated with the first sub-THz repeater, or a set of repeater spatial filter codebook capabilities associated with the first sub-THz repeater.

6. The apparatus of claim 5, wherein the set of repeater spatial filter codebook capabilities associated with the first sub-THz repeater comprises one or more of: a supported beam width, a supported quantity of spatial filters, or a boresight direction information associated with the dedicated transmission or reception unit for the spatial filter at the first sub-THz repeater.

7. The apparatus of claim 1, wherein the first wireless device is a first sub-THz repeater, and wherein the capability indication further indicates a quantity of simultaneous connections supported by the first sub-THz repeater.

8. The apparatus of claim 7, wherein the simultaneous connections are configured to be supported by a signal combiner or a signal splitter at the first sub-THz repeater.

9. The apparatus of claim 7, wherein the simultaneous connections comprise a first connection for communicating directly with the UE or a second wireless device and a second connection for communicating directly with the network entity or a third wireless device.

10. The apparatus of claim 1, wherein the first wireless device is selected based on the capability indication from a set of candidate wireless devices and based on one or more synchronization and beam management sessions with a second wireless device or the network entity.

11. The apparatus of claim 1, wherein the first wireless device has a line-of-sight (LOS) connection with the network entity or with a second wireless device involved in the sub-THz communication associated with the UE.

12. The apparatus of claim 1, wherein the capability indication is included in control information signaled over the primary cell.

13. The apparatus of claim 12, wherein the first wireless device is a first sub-THz repeater, and wherein the control information further comprises at least one of: a radio resource control (RRC) configuration associated with the capability indication, or repeater location information associated with the first sub-THz repeater.

14. The apparatus of claim 1, wherein the first wireless device has a direct link with the network entity, a direct link with the UE, or two direct links with two different wireless devices.

15. An apparatus for wireless communication at a network entity, comprising:
a memory; and
at least one processor coupled to the memory and, based at least in part on information stored in the memory, the at least one processor is configured to:
establish a first communication with a user equipment (UE) and a first sub-Terahertz (THz) repeater on a primary cell;
receive, from the first sub-THz repeater via the primary cell, a capability indication related to a sub-THz band;
transmit an activation for a sub-THz communication for the UE, the sub-THz communication being on a first frequency range that does not include a second frequency of the first communication;
transmit, for the first sub-THz repeater based on the capability indication via the primary cell, the activation for the sub-THz communication and at least one configuration of a synchronization and beam management session for the first sub-THz repeater;
communicate, via the primary cell, scheduling information for at least one data channel transmission over the sub-THz band for the UE; and
communicate, via the first sub-THz repeater and the sub-THz communication, the at least one data channel transmission for the UE.

16. The apparatus of claim 15, wherein the capability indication indicates a quantity of different non-simultaneous connections associated with different spatial directions or at least non-fully overlapping spatial ranges supported by the first sub-THz repeater.

17. The apparatus of claim 16, wherein each connection of the different non-simultaneous connections is associated with a dedicated transmission or reception unit with a spatial filter at the first sub-THz repeater.

18. The apparatus of claim 17, wherein the dedicated transmission or reception unit with the spatial filter is a dedicated lens-based beamformer, and wherein the dedicated lens-based beamformer points to a spatial direction associated with the dedicated lens-based beamformer or covers a spatial range associated with the dedicated lens-based beamformer.

19. The apparatus of claim 17, wherein the capability indication further comprises at least one of: a repeater type associated with the first sub-THz repeater, at least one transmit power, at least one transmit power category or at least one effective isotropic radiate power (EIRP) associated with at least one connection associated with the first sub-THz repeater, spatial coverage information for at least one spatial sector associated with at least one connection; a mobility type associated with the first sub-THz repeater, or a set of repeater spatial filter codebook capabilities associated with the first sub-THz repeater.

20. The apparatus of claim 19, wherein the set of repeater spatial filter codebook capabilities associated with the first sub-THz repeater comprises one or more of: a supported beam width, a supported quantity of spatial filters, or a boresight direction information associated with the dedicated transmission or reception unit for the spatial filter at the first sub-THz repeater.

21. The apparatus of claim 15, wherein the capability indication further indicates a quantity of simultaneous connections supported by the first sub-THz repeater.

22. The apparatus of claim 21, wherein the simultaneous connections are configured to be supported by a signal combiner or a signal splitter at the first sub-THz repeater.

23. The apparatus of claim 21, wherein the simultaneous connections comprise a first connection for communicating directly with the UE or a second wireless device and a second connection for communicating directly with the network entity or a third wireless device.

24. The apparatus of claim 15, wherein the at least one processor is further configured to:
determine a set of candidate wireless devices upon initial connection with each wireless device of the set of candidate wireless devices based on respective location information and respective capability indication associated with each wireless device of the set of candidate wireless devices;
test, based on synchronization and beam management session for a first wireless device of the set of candidate wireless devices and configure synchronization and beam management session associated with at least one additional wireless device of the set of candidate wireless devices, a set of connection links associated with the set of candidate wireless devices; and
select the at least one sub-THz repeater from the set of candidate wireless devices based on the test.

25. The apparatus of claim 15, wherein the first sub-THz repeater has a line-of-sight (LOS) connection with the network entity or with a second wireless device involved in the sub-THz communication associated with the UE.

26. The apparatus of claim 15, wherein the capability indication is included in control information signaled over the primary cell.

27. The apparatus of claim 26, and wherein the control information further comprises at least one of: a radio resource control (RRC) configuration determined by the network entity at least in part on the capability indication, or repeater location information associated with the first sub-THz repeater.

28. The apparatus of claim 15, wherein the first sub-THz repeater has a direct link with the network entity, a direct link with the UE, or two direct links with two different wireless devices.

29. A method of wireless communication at a network entity, comprising:
establishing a first communication with a user equipment (UE) on a primary cell;
receiving, from a first sub-Terahertz (THz) repeater via the primary cell, a capability indication;
transmitting an activation for a sub-THz communication for the UE, the sub-THz communication being on a first frequency range that does not include a second frequency of the first communication;
transmitting, for the first sub-THz repeater via the primary cell, the activation for the sub-THz communication and at least one configuration of synchronization and beam management session for the at least one sub-THz repeater;
communicating, via the primary cell, scheduling information for at least one data channel transmission; and
communicating, via the first sub-THz repeater and the sub-THz communication, the at least one data channel transmission.

30. A method of wireless communication at a first wireless device, comprising:
establishing a first communication with a user equipment (UE) and a first sub-Terahertz (THz) repeater on a primary cell;
receiving, from the first sub-THz repeater via the primary cell, a capability indication related to a sub-THz band;
transmitting an activation for a sub-THz communication for the UE, the sub-THz communication being on a first frequency range that does not include a second frequency of the first communication;
transmitting, for the first sub-THz repeater based on the capability indication via the primary cell, the activation for the sub-THz communication and at least one configuration of synchronization and beam management session for the first sub-THz repeater;
communicating, via the primary cell, scheduling information for at least one data channel transmission over the sub-THz band for the UE; and
communicating, via the first sub-THz repeater and the sub-THz communication, the at least one data channel transmission for the UE.
